(19) United States
(12) Patent Application Publication
(10) Pub. No.: US 2010/0265156 A1
(43) Pub. Date: Oct. 21, 2010

(54) ARRAY ANTENNA DEVICE

(75) Inventors: Yoshiaki MINAMI, Gotenba-shi (JP); Toshiaki Watanabe, Owariasahi-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/617,269

(22) Filed: Nov. 12, 2009

(30) Foreign Application Priority Data
Apr. 17, 2009 (JP) 2009-101295

(51) Int. Cl. H01Q 21/00

(52) U.S. Cl. 343/893; 343/843; 343/844

(57) ABSTRACT

Provided is an array antenna device which is capable of easily setting radiation coefficients of respective antenna elements and easily matching impedances. The array antenna device 1 according to the present invention comprises: a plurality of antenna blocks 4 provided on a front side of a dielectric substrate 3, wherein each of the plurality of antenna blocks 4 includes: a feed microstrip line 6; and an antenna element 2 connected to a middle part 61 of the feed microstrip line 6, wherein the feed microstrip line 6 has: the middle part 61; an input side impedance matching element 7 connected to the middle part 61 so as to be distant from the antenna element 2; and an output side impedance matching element 8 connected to the middle part 61 so as to be distant from the antenna element 2.

### BACKGROUND OF THE INVENTION

1. Field of the Invention

The present invention relates to an array antenna device and more particularly, to an array antenna device which is capable of easily setting radiation coefficients of respective antenna elements and easily matching impedances.

2. Description of the Background Art

A conventional art of a series-fed planar array antenna device (hereinafter, referred to as an array antenna device) will be described. FIG. 7 is a diagram illustrating one example of the conventional array antenna device. FIG. 8 is a diagram illustrating a part of the array antenna device shown in FIG. 7. In general, the array antenna device is configured, as shown in FIG. 7, by providing a front side of a dielectric substrate 50, whose back side is provided with a conductive grounding plate, with a microstrip line which is configured by connecting a plurality of antenna elements 41 on a lateral side of a feed line 40. As shown in FIG. 8, in an antenna block 42 which comprises one of the antenna elements 41 and a feed line 40 located behind and ahead of the one of the antenna elements 41, a partial electric power 32 of an electric power 31 inputted from an input end 30 of the feed line 40 is coupled to the one of the antenna elements 41, and an electro-magnetic wave of the partial electric power 32 is radiated. When a mismatch between impedances behind and ahead of a connecting point of the one of the antenna elements 41 occurs, a partial electric power 34 of the electric power 31 returns to the input end 30. Because of the above-described occurrence, an equation “radiated electric power 32=inputted electric power 31−reflected electric power 34−outputted electric power 35” is derived. The electric power 35 is outputted toward the antenna element 41 in the antenna block 42 in the next stage, and also in the antenna element 41 in the next stage, an electric power flow occurs which is similar to the electric power flow having occurred in the antenna block 42 in the previous stage.

When the mismatch between the impedances occurs, the reflection of the electric power arises as described above. Therefore, it is required to prevent the mismatch between the impedances. Conventionally, in order to match the impedances, impedance matching elements 36 are provided at connecting portions of respective antenna elements 38 as shown in FIG. 9 (refer to FIG. 21 of Japanese Patent No. 3306592). Corner portions of the antenna elements 38 are connected to lateral sides of the impedance matching elements 36, respectively. Each of the impedance matching elements 36 constitutes a part of the feed line 40. The feed line 40 is connected to ends of main portions 60 and includes the impedance matching elements 36, each of which has a larger width than that of each of the main portions 60.

However, in a case where the impedance matching elements 36 are provided as shown in FIG. 9, there arises a problem that it is difficult to set radiation coefficients which determine radiation amounts of electro-magnetic waves from the antenna elements 38. The reason for this will be described blow.

In an array antenna device shown in FIG. 9, a radiation coefficient A_#n of the antenna element 38 in the nth stage can be expressed by the following equation 1.

A_{—}#n=Zf_{—}#n/(Zr_{—}#n+Zf_{—}#n) (Equation 1)

Here, Zf_#n represents an impedance on an output side ahead of the connecting point 39 of the antenna element 38 in the nth stage and Zr_#n represents the radiation impedance of the antenna element 38 in the nth stage.

The radiation impedance Zr_#n is determined based on a width of the antenna element 38 in the nth stage, a width of the feed line at the connecting point 39 of the antenna element 38 in the nth stage (a width of the main portion 60 and a width of the impedance matching element 36), a shape in which the antenna element 38 in the nth stage and the feed line 40 are connected (an amount in which and an angle at which the antenna elements 38 is inserted into the feed line 40), and the like.

Each of the antenna elements 38 is connected to each of the impedance matching elements 36. Therefore, the radiation impedance Zr_#n in this case is difference from a radiation impedance Zr_#n in a case where the impedance matching elements 36 are not provided (that is, a case where each of the antenna elements 38 is directly connected to each of the main portions 60).

In order to optimize a shape and a gain of a beam, it is required to adjust the radiation coefficients A of the respective antenna elements 38 in a design stage of the array antenna device. Furthermore, in order to prevent reflection of the electric power at the connecting point 39, it is required to match the impedances. [0009]In an example shown in FIG. 9, however, when in order to match an impedance ahead of the connecting point 39 (a synthetic impedance of the impedances Zr_#n and Zf_#n) and an impedance behind the connecting point 39, a width of each of the impedance matching elements 36 is changed, a value of the impedance Zr_#n comes to be changed. Accordingly, because the impedance Zr_#n is once set and thereafter, the matching of the impedances is performed, it is required to set the impedance Zr_#n once more. When the impedance Zr_#n is set again and thereafter, the matching of the impedances is performed again, a value of the impedance Zr_#n is changed again and it is required to set the impedance Zr_#n again. In other words, setting of the impedance Zr_#n is repeated, thereby leading to a problem that it is difficult to set an appropriate impedance.

### SUMMARY OF THE INVENTION

With the above-described problem in mind, the present invention was created. An object of the present invention is to provide an array antenna device which is capable of easily setting radiation coefficients of respective antenna elements and easily matching impedances.

A first aspect of the present invention is directed to an array antenna device including a plurality of antenna elements, comprising: a dielectric substrate having a conductive grounding plate provided on a back side thereof; and a plurality of antenna blocks provided on a front side of the dielectric substrate and connected in series, wherein each of the plurality of antenna blocks includes: a feed microstrip line; and an antenna element connected in a ramified manner to a middle part of the feed microstrip line, wherein the feed microstrip line has: the middle part; an input side impedance matching element connected to an input end of the middle part so as to be distant from the antenna element; and an output side impedance matching element connected to an output end of the middle part so as to be distant from the antenna element, and wherein the input side impedance matching element in each stage is connected to the output side impedance matching element in a preceding stage.

According to the first aspect, setting of the radiation coefficient A for each of the antenna elements and matching of the impedances can be facilitated. Hereinafter, the setting and the matching will be specifically described. The radiation coefficient A for each of the antenna elements in the antenna blocks is determined based on a ratio of an impedance Zr (radiation impedance of each of the antenna elements) exerted from the antenna element connecting point toward a side of each of the antenna elements and an impedance Zf exerted from the antenna element connecting point toward an output side (feed downstream side). In other words, the radiation coefficient A for each of the antenna elements can be set by using the following equation: A=Zf/(Zr+Zf)=1/((Zr/Zf)+1). In order to change the radiation coefficient A, it is only required to change either of the impedance Zr or the impedance Zf. The impedance Zr can be changed by changing a width of each of the antenna elements. The impedance Zf can be changed by changing a line width of the output side impedance matching element (in other words, by changing the characteristic impedance of the output side impedance matching element). Each of the output side impedance matching elements is located so as to be distant from each of the antenna elements. Therefore, even when the line width of each of the output side impedance matching elements is changed, no influence is exerted on the impedance Zr. In addition, even when the width of each of the antenna elements is changed, no influence is exerted on the impedance Zf. Thus, only through changing either of the impedance Zr or the impedance Zf, the radiation coefficient A can be easily set to be a desired value.

Since by setting the radiation coefficient A, the impedance Zr or the impedance Zf is changed, the impedance (that is, a synthetic impedance of the impedances Zr and Zf: Zr×Zf/(Zr+Zf)) exerted ahead of the antenna element connecting point is changed. Matching the impedances ahead of and behind the antenna element connecting point is performed by adjusting the line width of the input side impedance matching element. Since the input side impedance matching element is located so as to be distant from the antenna element connecting point, even when the line width of the input side impedance element is changed, no influence is exerted on the synthetic impedance of the impedance Zr and the impedance Zf. Thus, matching the impedances ahead of and behind the antenna element connecting point can be easily performed.

In order to connect an input end of an antenna block in a certain stage to an output end of an antenna block in a stage (stage on a feed upstream side, viewed from said certain stage) which precedes the above-mentioned certain stage, it is required to match an input impedance of the antenna block in the above-mentioned certain stage and an output impedance of the antenna block in the preceding stage and thereby, to avoid the reflection of an electric power at a connecting portion between the antenna blocks. The input impedance of the antenna block in the above-mentioned certain stage can be set to be a desired value by changing the line width of the input side impedance matching element. Since the input side impedance matching element is located so as to be distant from the antenna element, even when the line width of the input side impedance matching element is changed, no influence is exerted on the impedance Zr and therefore, the radiation coefficient A which has been previously set is not changed. Thus, the input impedance can be easily set without necessity of considering any influence exerted on the impedance Zr.

As described above, the radiation coefficient in each of the stages can be set for each of the antenna blocks in an independent manner, thereby facilitating the setting of the radiation coefficients in the stages. In addition, the input impedance in the above-mentioned certain stage and the output impedance in the preceding stage can be easily matched, thereby allowing the array antenna device to be easily designed by designing each of the stages in an independent manner and thereafter, by mutually connecting the stages.

In a second aspect based on the first aspect, in the feed microstrip line, a length of the middle part behind an antenna element connecting portion is λg/4 and a length of the middle part ahead of the antenna element connecting portion is λg/4, and a length of the input side impedance matching element is λg/4 and a length of the output side impedance matching element is λg/4, wherein λg represents a wavelength of an electro-magnetic wave propagating through the microstrip line.

According to the second aspect, the setting of the radiation coefficients of the respective antenna elements and the matching of the impedances can be easily and appropriately performed.

In a third aspect based on the second aspect, a characteristic impedance zm2_#n is expressed by an equation (1) zm2_#n=SQRT((zo²×Zout_#n)/Zf_#n), wherein zo represents a characteristic impedance of the middle part in an nth stage, Zout_#n represents an impedance which is exerted from an output end of the output side impedance matching element in the nth stage toward an output side and results when it is assumed that an antenna block in a (n+1)th stage is connected to the output end, and Zf_#n represents an impedance exerted from a connecting point of one of the antenna elements in the nth stage toward the output side.

According to the third aspect, the impedance zm2_#n of each of the output side impedance matching elements can be easily calculated by using the simple equation (1).

In a fourth aspect based on any of the first, second, and third aspects, an impedance zm1_#n is expressed by an equation (2) zm1_#n=SQRT(zo²×Zin_#n×(Zr_#n+Zf_#n)/(Zr_#n×Zf_#n)), wherein zo represents a characteristic impedance of a feed strip line in the nth stage; Zin_#n represents an impedance on an input side in the nth stage; Zr_#n represents an impedance exerted from the connecting point of the one of the antenna elements in the nth stage toward the one of the antenna elements in the nth stage; and Zf_#n represents an impedance exerted from the connecting point of the one of the antenna elements in the nth stage toward the output side.

According to the fourth aspect, the impedance zm1_#n of each of the input side impedance matching elements can be easily calculated by using the simple equation (2).

According to the present invention, the radiation coefficients of the respective antenna elements and the matching of the impedances can be easily and appropriately performed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating an array antenna device according to a first embodiment of the present invention;

FIG. 2 is a diagram illustrating an enlarged one part of the array antenna device shown in FIG. 1 and showing one example of dimensions of each antenna block;

FIG. 3 is a diagram illustrating the enlarged one part of the array antenna device shown in FIG. 1 and showing impedances in the array antenna device;

FIG. 4 is a diagram showing a flow of an electric power in the array antenna device shown in FIG. 1;

FIG. 5 is a diagram illustrating an array antenna device according to a second embodiment of the present invention;

FIG. 6 is a diagram illustrating an enlarged one part of the array antenna device shown in FIG. 5;

FIG. 7 is a diagram illustrating a conventional array antenna device;

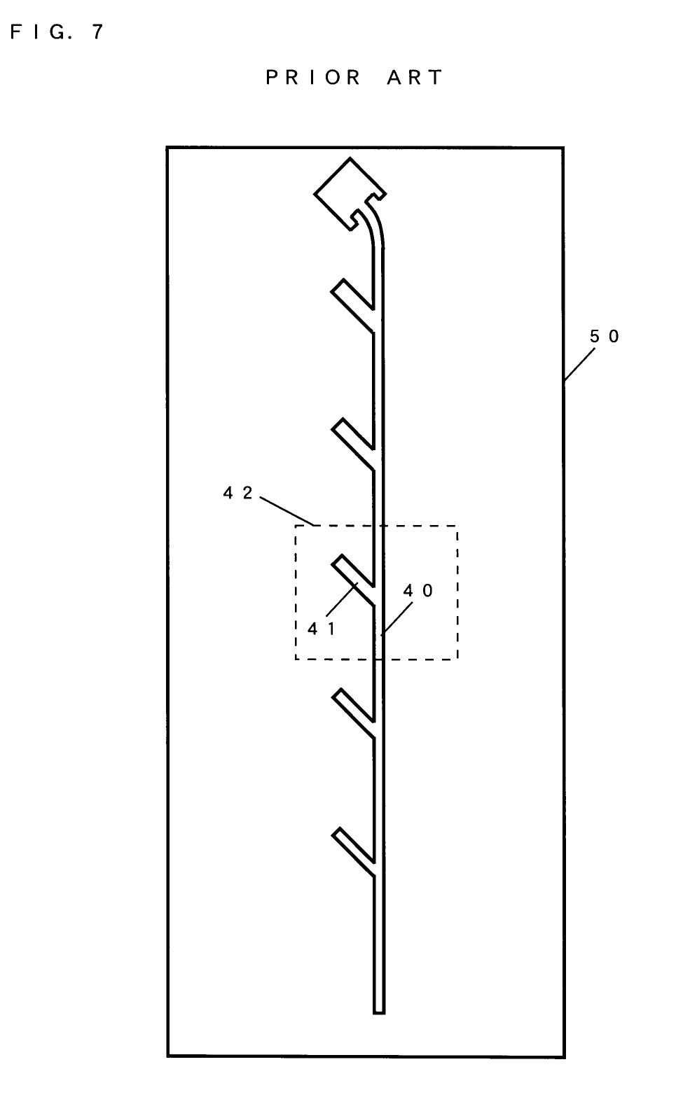

FIG. 8 is a diagram illustrating an enlarged one part of the array antenna device shown in FIG. 7; and

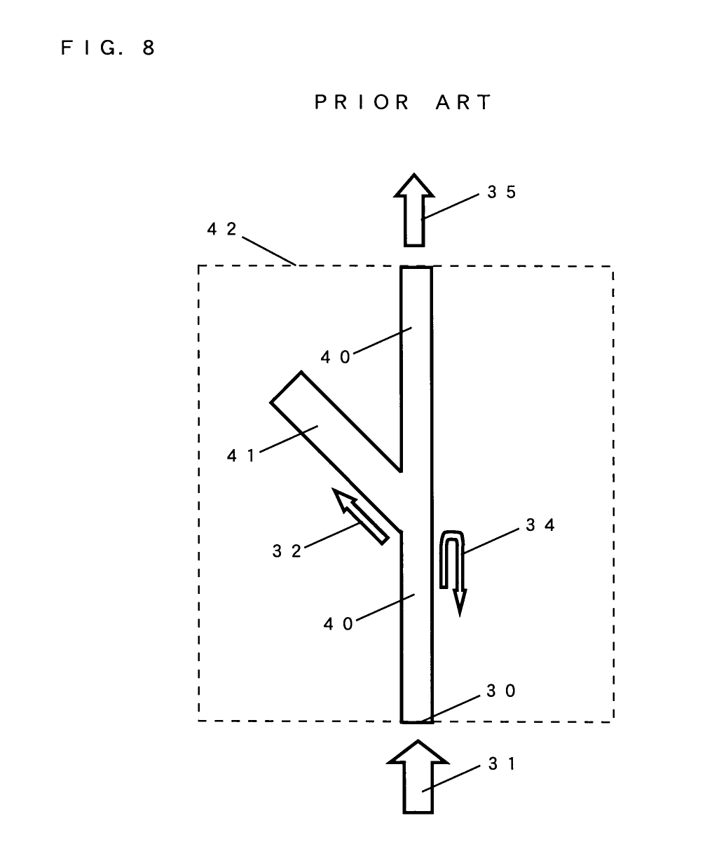

FIG. 9 is a diagram illustrating another conventional array antenna device.

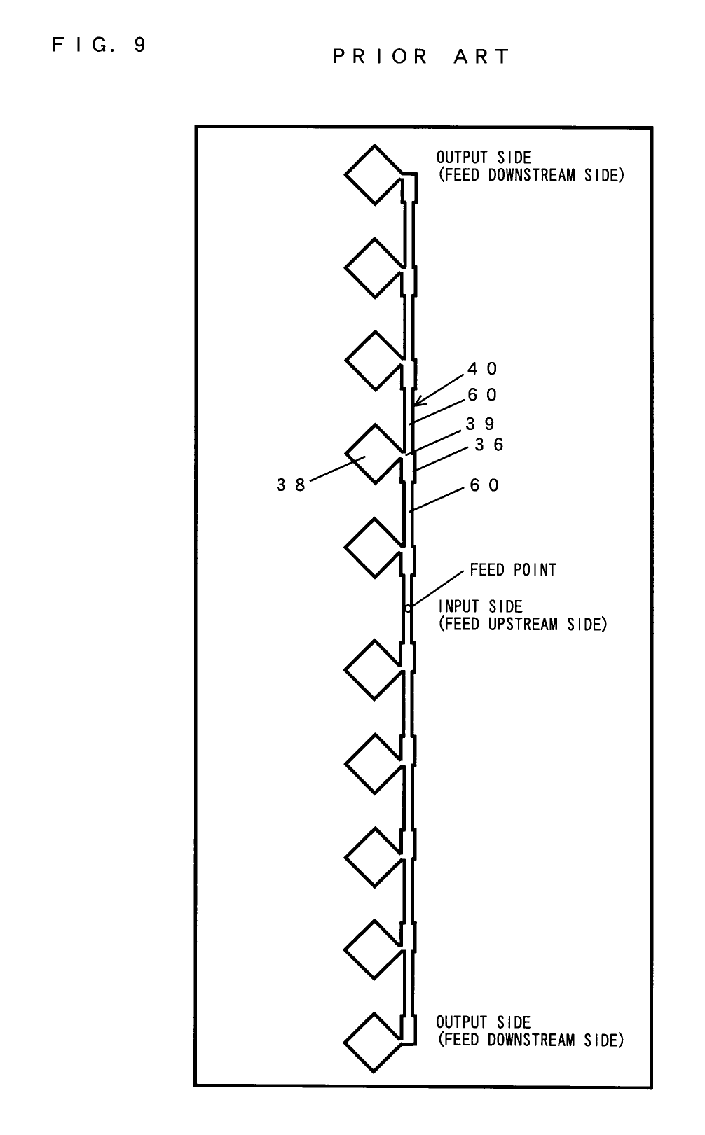

### DESCRIPTION OF THE PREFERRED EMBODIMENTS

### First Embodiment

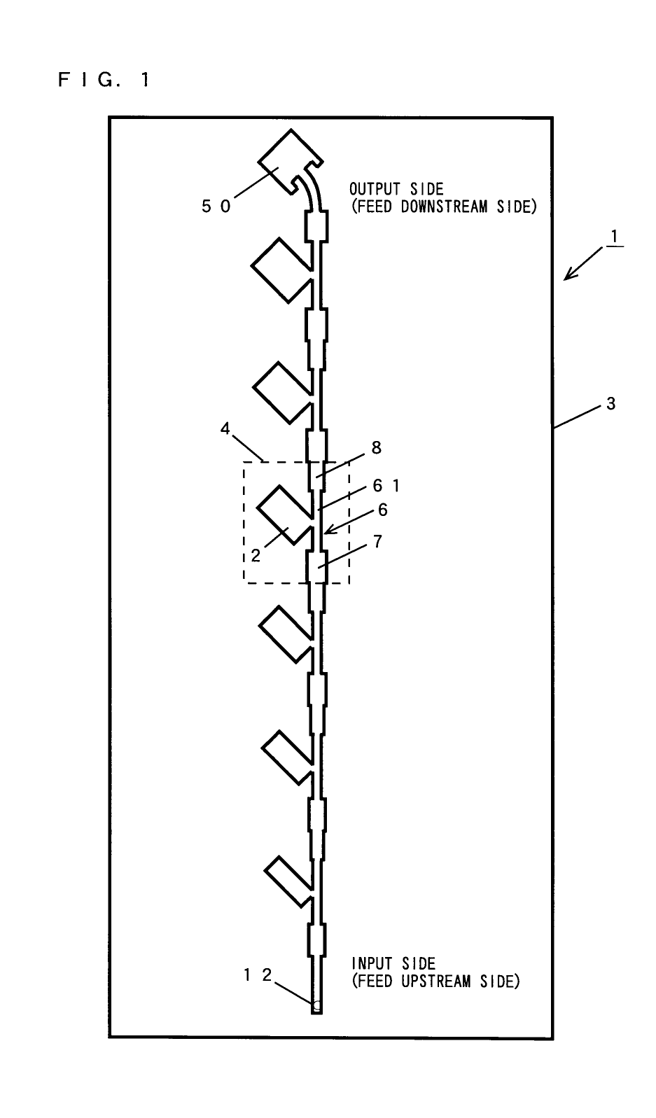

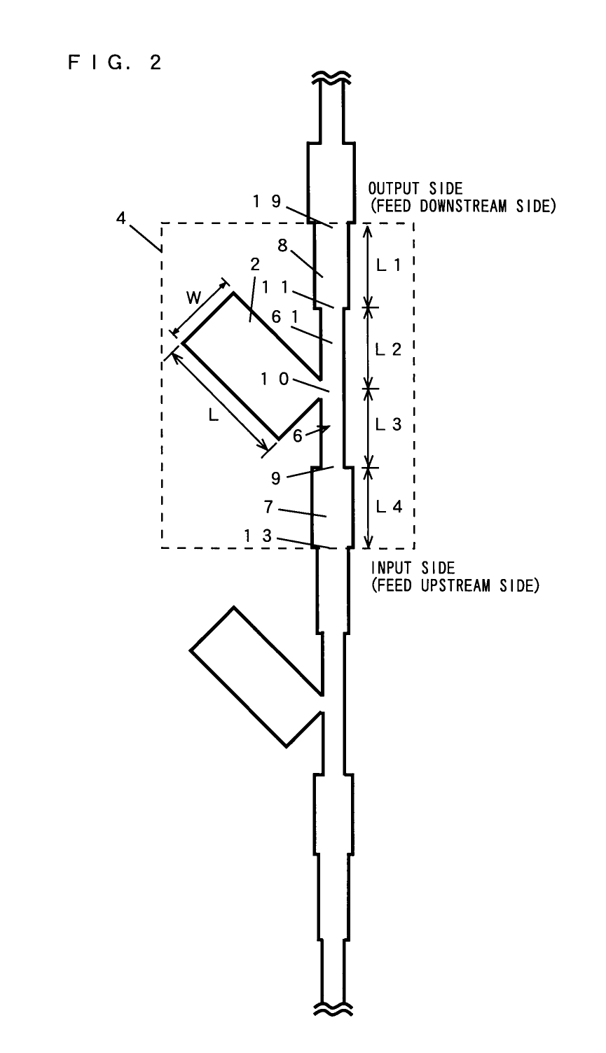

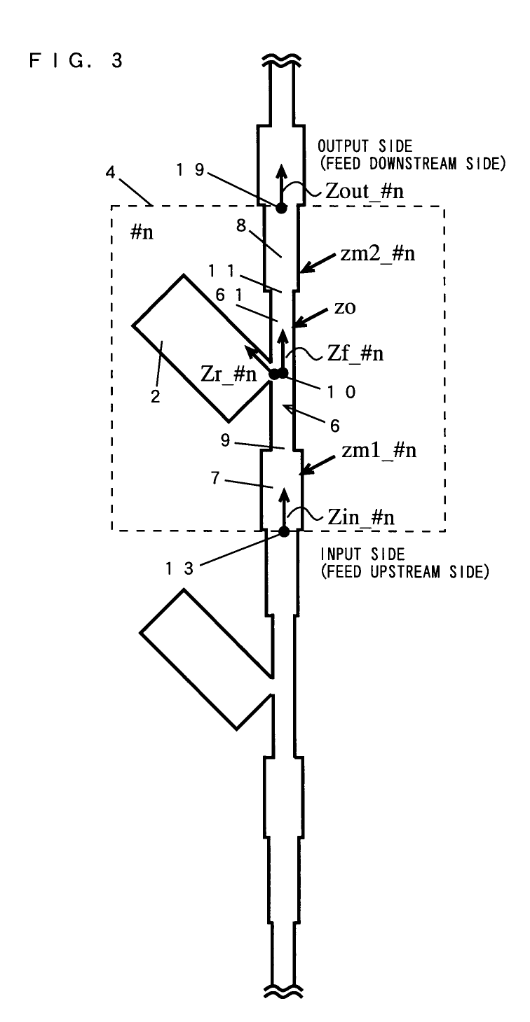

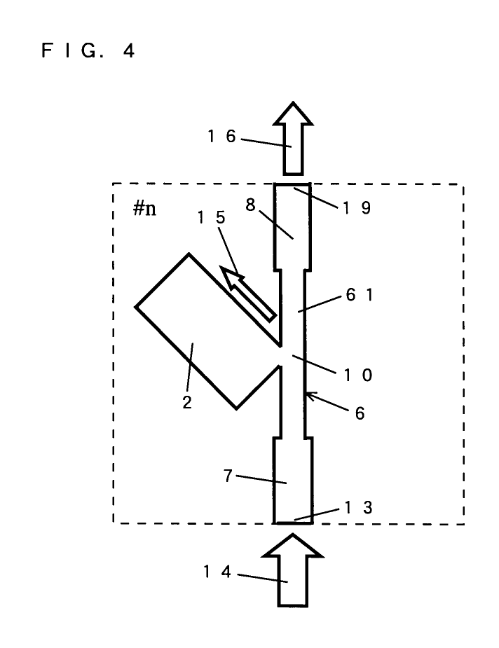

An array antenna device according to a first embodiment of the present invention will be described with reference to drawings. FIG. 1 is a diagram illustrating the array antenna device according to the first embodiment. FIG. 2 is a diagram illustrating enlarged one part of the array antenna device shown in FIG. 1 and showing one example of dimensions of each antenna block. FIG. 3 is a diagram illustrating the enlarged one part of the array antenna device shown in FIG. 1 and showing impedances in the array antenna device. FIG. 4 is a diagram showing a flow of an electric power in the array antenna device shown in FIG. 1.

As shown in FIGS. 1, 2, and 3, the array antenna device 1 according to the first embodiment comprises a plurality of antenna elements 2. The array antenna device 1 shown in FIG. 1 is a series-fed-type planar antenna in which direct feeding from linear feed strip lines 6 to linear antenna elements 2 is performed. Hereinafter, the array antenna device 1 will be described in detail.

The array antenna device 1 comprises a dielectric substrate 3 and a plurality of antenna blocks 4.

On a back side of the dielectric substrate 3, a conductive grounding plate (not shown) is provided, and on a front side of the dielectric substrate 3, which is opposite to the back side, the antenna blocks 4 which are conductive are provided.

The respective antenna blocks 4 are connected in series on the front side of the dielectric substrate 3.

Each of the respective antenna blocks 4 includes a feed microstrip line 6 and each of the antenna elements 2.

The feed microstrip lines 6 are linear microstrip lines which feed electric power to the antenna elements 2. Each of the feed microstrip lines 6 has a middle part 61, an input side impedance matching element 7, and an output side impedance matching element 8.

The middle part 61 in each of the antenna blocks 4 is strip-shaped and located at a longitudinal middle portion of each of the feed microstrip lines 6 and has a constant width spanning from an input end 9 to an output end 11, as shown in FIG. 2. At a middle portion of a lateral side of the middle part 61, each of the antenna elements 2 is connected. In the middle part 61, each length (L2 and L3) behind and ahead of an antenna element connecting point 10 (which is a center point of a connecting portion and hereinafter, referred to as a connecting point 10) is ¼ (λg/4) of a wavelength of an electro-magnetic wave which propagates through the feed microstrip line 6. In each of the antenna blocks 4, the length L3 spanning from the input end 9 of the middle part 61 to the connecting point 10 is λg/4 and the length L2 spanning from the connecting point 10 to the output end 11 of the middle part 61 is λg/4. In the respective antenna blocks 4, the lengths of the feed microstrip lines 6 are, for example, the same as one another and the widths of the feed microstrip lines 6 are, for example, the same as one another. Note that the wavelength λg is obtained by shortening, by a permittivity of the dielectric substrate 3, a wavelength λ of a predetermined electro-magnetic wave which propagates through a vacuum.

Each of the antenna elements 2 is a microstrip line which is linear in shape and connected in a ramified manner to the middle part 61 of the feed microstrip line 6. In an example shown in FIG. 2, each of the antenna elements 2 is connected on one lateral side of the feed microstrip line 6 so as to be inclined (for example, at an angle of 45 degrees) toward an output side of the feed microstrip line 6 (that is, a feed downstream side). Note that each of the antenna elements 2 may be connected to the middle part 61 of the feed microstrip line 6 so as to be inclined toward an input side of the microstrip line 6 (that is, a feed upstream side) or so as to extend in a direction perpendicular to the microstrip line 6. Each of the antenna elements 2 is formed so as to be of a rectangular shape and one of corners thereof is directly connected to the feed microstrip lines 6. As shown in FIG. 1, widths W of the antenna elements 2 increase gradually from the input sides (that is, the feed upstream sides) toward the output sides (that is, the feed downstream sides). This allows a radiation coefficient A of each of the antenna elements 2 to be increased gradually from the input side of each of the antenna blocks 4 toward the output side of each of the antenna blocks 4. A radiation coefficients A_#n of the antenna element 2 in the antenna block 4 in the nth stage is expressed by an equation A_#n=Zf_#n/(Zr_#n+Zf_#n)=1/((Zr_#n/Zf_#n)+1). Here, Zr_#n is a radiation impedance exerted from a connecting point 10 of the one of the antenna elements 2 in the nth stage toward a side of the one of the antenna elements 2 in the nth stage, and Zf_#n is an impedance exerted from the connecting point 10 of the one of the antenna elements 2 in the nth stage toward an output side. The one of the antenna elements 2 radiates an electro-magnetic wave from an end portion thereof A length L of each of the antenna elements 2 is set so as to be, for example, a half (λg/2) of a wavelength λg determined in accordance with a desired frequency.

An input end of the output side impedance matching element 8 is connected to an output end 11 of the middle part 61. A length L1 of the output side impedance matching element 8 is set to be λg/4. A characteristic impedance zm2_#n (see FIG. 3) of the output side impedance matching element 8, which allows the impedance Zf_#n to be set as a desired value, is expressed by the following equation 1.

zm2_{—}#n=SQRT((zo²×Zout_{—}#n)/Zf_{—}#n) (Equation 1)

Here, zo represents a characteristic impedance of the middle part 61 in the nth stage; Zout_#n represents an impedance which is exerted from an output end 19 of the output side impedance matching element 8 in the nth stage toward an output side and results when it is assumed that an antenna block in the (n+1)th stage is connected to the output end 19; Zf_#n represents the impedance exerted from the connecting point 10 of the one of the antenna elements 2 in the nth stage toward the output side; and SQRT represents a square root.

An output end of the input side impedance matching element 7 is connected to an input end 9 of the middle part 61. A length L4 of the input side impedance matching element 7 is set to be λg/4. A characteristic impedance zm1_#n (see FIG. 3) of the input side impedance matching element 7, which allows an input impedance Zin_#n of the one of the antenna blocks 4 to be set as a desired value, is expressed by the following equation 2.

zm1_{—}#n=SQRT(zo²×Zin_{—}#n×(Zr_{—}#n+Zf_{—}#n)/(Zr_{—}#n×Zf_{—}#n)) (Equation 2)

Here, zo represents a characteristic impedance of the feed strip line 6 in the nth stage; Zin_#n represents an impedance on an input side in the nth stage; Zr_#n represents an impedance exerted from the connecting point 10 of the one of the antenna elements 2 in the nth stage toward the one of the antenna elements 2 in the nth stage; Zf_#n represents the impedance exerted from the connecting point 10 of the one of the antenna element 2 in the nth stage toward the output side; and SQRT represents a square root. Note that the characteristic impedance zm1_#n of the input side impedance matching element 7 is set after the characteristic impedance zm2_#n of the output side impedance matching element 8 has been set.

The input end of the input side impedance matching element 7 in each stage is connected to an output end of the output side impedance matching element 8 of each of the antenna blocks 4 in a previous stage.

By equalizing the input impedance Zin_#n of the one of the antenna blocks 4 in the nth stage with an impedance Zout_#n−1 resulting when it is assumed that the input end of the one of the antenna blocks 4 in the nth stage is connected to an output end of one of the antenna blocks in the (n−1)th stage (previous stage), the impedances can be matched, thereby allowing the antenna blocks 4 in the nth stage and the (n−1)th stage to be connected so as to avoid the reflection of the electric power at a boundary portion between the antenna blocks 4 in the nth stage and the (n−1)th stage. Through similarly connecting all of the antenna blocks in all stages in order, the array antenna device 1 is configured. As described above, the radiation coefficient A for each of the antenna blocks 4 can be adjusted in an independent manner, whereby designing the array antenna device 1 can be facilitated.

At a terminal end of the array antenna device 1, a matching terminal end element 50 to absorb an electric power remaining at the terminal end is provided.

An operation of the array antenna device 1 will be described. When an electric power is fed at a feed point 12 (see FIG. 1) of each of the antenna blocks 4 in the array antenna device 1, as shown in FIG. 4, a partial electric power 15 of an electric power 14 inputted from an input end 13 of the input side impedance matching element 7 is coupled to the antenna element 2 in each of the antenna blocks 4 and an electro-magnetic wave of the electric power is radiated (radiation electric power 15). An electric power (output electric power 16) resulting when the radiation electric power 15 is subtracted from the input electric power 14 is outputted from the output end 19 of the output side impedance matching element 8 to the antenna block 4 in the next stage.

Since providing the input side impedance matching element 7 allows the impedances of the antenna blocks 4 to be matched, the partial electric power of the inputted electric power 14 does not return to a side of the feed point 12. In other words, since a reflection loss is small, the electro-magnetic wave can be efficiently radiated from each of the antenna elements 2.

In addition, setting of the radiation coefficient A for each of the antenna elements 2 and matching of the impedances can be facilitated. Hereinafter, the setting and the matching will be specifically described. The radiation coefficient A for each of the antenna elements in the antenna blocks 4 is determined based on a ratio of an impedance Zr (radiation impedance of each of the antenna elements) exerted from the antenna element connecting point 10 toward a side of each of the antenna elements 2 and an impedance Zf exerted from the antenna element connecting point 10 toward an output side (downstream side). In other words, the radiation coefficient A for each of the antenna elements can be set by using the following equation: A=Zf/(Zr+Zf)=1/((Zr/Zf)+1). In order to change the radiation coefficient A, it is only required to change either of the impedance Zr or the impedance Zf. The impedance Zr can be changed by changing a width of each of the antenna elements 2. The impedance Zf can be changed by changing a line width of the output side impedance matching element 8 (in other words, by changing the characteristic impedance of the output side impedance matching element 8). Each of the output side impedance matching elements 8 is located so as to be distant from each of the antenna elements 2. Therefore, even when the line width of each of the output side impedance matching elements 8 is changed, no influence is exerted on the impedance Zr. In addition, even when the width of each of the antenna elements 2 is changed, no influence is exerted on the impedance Zf. Thus, only through changing either of the impedance Zr or the impedance Zf, the radiation coefficient A can be easily set to be a desired value.

Since by setting the radiation coefficient A, the impedance Zr or the impedance Zf is changed, the impedance (that is, a synthetic impedance: Zr×Zf/(Zr+Zf)) exerted ahead of the antenna element connecting point 10 is changed. Matching the impedances ahead of and behind the antenna element connecting point 10 is performed by adjusting the line width of the input side impedance matching element 7. Since the input side impedance matching element 7 is located so as to be distant from the antenna element connecting point 10, even when the line width of the input side impedance element 7 is changed, no influence is exerted on the synthetic impedance of the impedance Zr and the impedance Zf. Thus, matching the impedances ahead of and behind the antenna element connecting point 10 can be easily performed.

In order to connect an input end 13 of an antenna block 4 in a certain stage to an output end of an antenna block in a stage (stage on a feed upstream side, viewed from said certain stage) which precedes the above-mentioned certain stage, it is required to match an input impedance Zin_#n of the antenna block 4 in the above-mentioned certain stage and an output impedance Zout_#n−1 of the antenna block in the preceding stage and thereby, to avoid the reflection of an electric power at a connecting portion between the antenna blocks. The input impedance Zin_#n of the antenna block 4 in the above-mentioned certain stage can be set to be a desired value by changing the line width of the input side impedance matching element 7. Since the input side impedance matching element 7 is located so as to be distant from the antenna element 2, even when the line width of the input side impedance matching element 7 is changed, no influence is exerted on the impedance Zr and therefore, the radiation coefficient A which has been previously set is not changed. Thus, the input impedance Zin_#n can be easily set without necessity of considering any influence exerted on the impedance Zr.

As described above, the radiation coefficient in each of the stages can be set for each of the antenna blocks 4 in an independent manner, thereby facilitating the setting of the radiation coefficients A in the stages. In addition, the input impedance Zin_#n in the above-mentioned certain stage and the output impedance Zout_#n−1 in the preceding stage can be easily matched, thereby allowing the array antenna device 1 to be easily designed by designing each of the stages in an independent manner and thereafter, by connecting the stages one another.

Note that although in the example shown in FIGS. 1, 2, and 3, the width of the input side impedance matching element 7 and the width of the output side impedance matching element 8 in the preceding stage are different from each other, these widths may be the same as each other.

### Second Embodiment

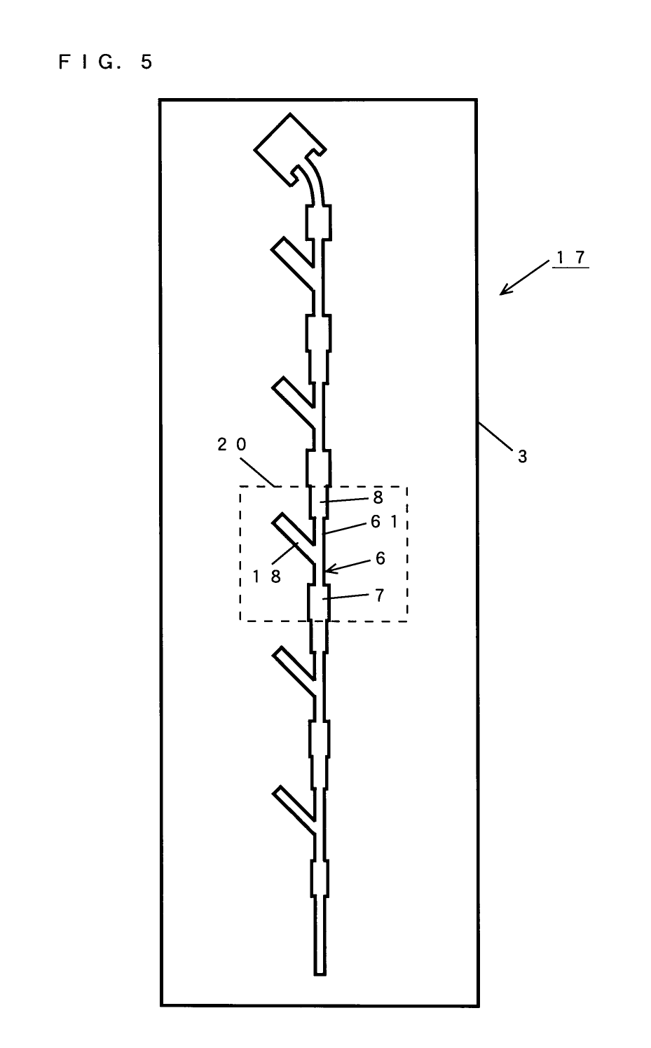

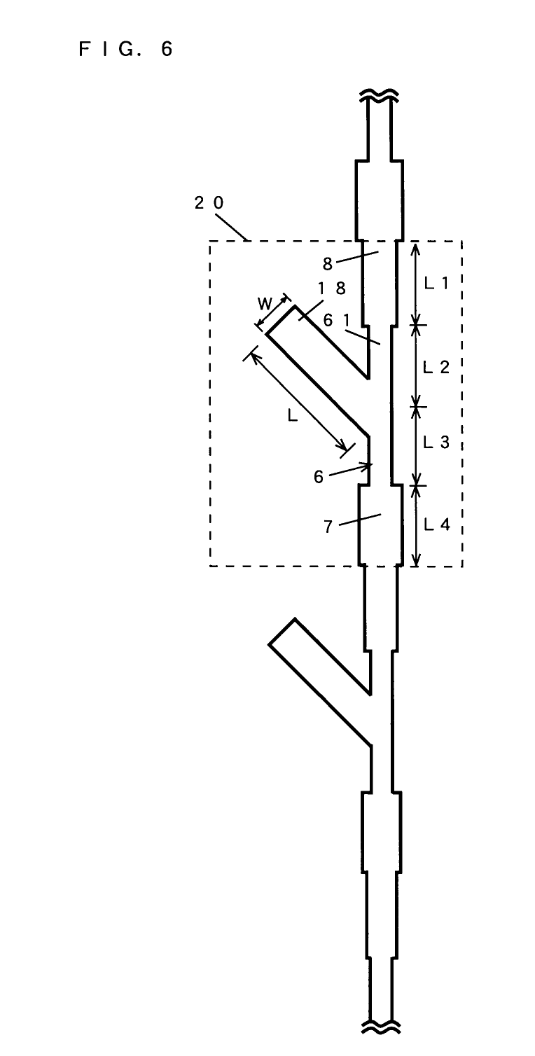

An array antenna device according to a second embodiment of the present invention will be described with reference to drawings. FIG. 5 is a diagram illustrating the array antenna device according to the second embodiment of the present invention. FIG. 6 is a diagram illustrating enlarged one part of the array antenna device shown in FIG. 4. Note that the same components as those in the first embodiment are denoted with the same reference numerals and description thereof will be omitted.

The array antenna device 17 according to the second embodiment comprises a dielectric substrate 3 and a plurality of antenna blocks 20.

On a back side of the dielectric substrate 3, a conductive grounding plate (not shown) is provided, and on a front side of the dielectric substrate 3, which is opposite to the back side, the antenna blocks 20 which are conductive are provided.

The array antenna device 17 according to the second embodiment is different from the array antenna device 1 according to the first embodiment in a shape in which each antenna element 18 and each feed microstrip line 6 are connected. Other than the shape, a configuration of the array antenna device 17 is the same as that of the array antenna device 1 according to the first embodiment. Lengths L1, L2, L3, and L4 are each set to be λg/4.

In the second embodiment, the antenna element 18 is connected to a lateral side of the feed strip line 6 such that a whole of one short side of the antenna element 18 is buried in the feed microstrip line 6. In other words, a depth at which the antenna elements 18 is inserted into the feed strip line 6 is different from that in the first embodiment.

In the second embodiment, since a reflection loss of an electric power is reduced as similarly to in the first embodiment, an electro-magnetic wave can be efficiently radiated from each of the antenna elements 18. In addition, in the second embodiment, setting of radiation coefficients of the antenna elements 18 and matching of impedances can be easily and appropriately performed.

The present invention is applicable to an array antenna device or the like included in an in-vehicle radar apparatus which is demanded to change a shape of a beam and a gain in accordance with use applications.

While the invention has been described in detail, the foregoing description is in all aspects illustrative and not restrictive. It is understood that numerous other modifications and variations can be devised without departing from the scope of the invention.

What is claimed is:

1. An array antenna device including a plurality of antenna elements, comprising:
a dielectric substrate having a conductive grounding plate provided on a back side thereof; and
a plurality of antenna blocks provided on a front side of the dielectric substrate and connected in series,
wherein each of the plurality of antenna blocks includes:
a feed microstrip line; and
an antenna element connected in a ramified manner to a middle part of the feed microstrip line,
wherein the feed microstrip line has:
the middle part;
an input side impedance matching element connected to an input end of the middle part so as to be distant from the antenna element; and
an output side impedance matching element connected to an output end of the middle part so as to be distant from the antenna element, and
wherein the input side impedance matching element in each stage is connected to the output side impedance matching element in a preceding stage.

2. The array antenna device according to claim 1,
wherein in the feed microstrip line,
a length of the middle part behind an antenna element connecting portion is λg/4 and a length of the middle part ahead of the antenna element connecting portion is λg/4, and
a length of the input side impedance matching element is λg/4 and a length of the output side impedance matching element is λg/4, wherein λg represents a wavelength of an electro-magnetic wave propagating through the microstrip line.

3. The array antenna device according to claim 1,
wherein a characteristic impedance zm2_#n is expressed by an equation (1) zm2_#n=SQRT((zo²×Zout_#n)/Zf_#n), wherein zo represents a characteristic impedance of the middle part in an nth stage, Zout_#n represents an impedance which is exerted from an output end of the output side impedance matching element in the nth stage toward an output side and results when it is assumed that an antenna block in a (n+1)th stage is connected to the output end, and Zf_#n represents an impedance exerted from a connecting point of one of the antenna elements in the nth stage toward the output side.

4. The array antenna device according to claim 1,
wherein an impedance zm1_#n is expressed by an equation (2) zm1_#n=SQRT(zo²×Zin_#n×(Zr_#n+Zf_#n)/(Zr_#n×Zf_#n)), wherein zo represents a characteristic impedance of a feed strip line in the nth stage; Zin_#n represents an impedance on an input side in the nth stage; Zr_#n represents an impedance exerted from the connecting point of the one of the antenna elements in the nth stage toward the one of the antenna elements in the nth stage; and Zf_#n represents an impedance exerted from the connecting point of the one of the antenna elements in the nth stage toward the output side.

5. The array antenna device according to claim 3,
wherein an impedance zm1_#n is expressed by an equation (2) zm1_#n=SQRT(zo²×Zin_#n×(Zr_#n+Zf_#n)/(Zr_#n×Zf_#n)), wherein zo represents a characteristic impedance of a feed strip line in the nth stage; Zin_#n represents an impedance on an input side in the nth stage; Zr_#n represents an impedance exerted from the connecting point of the one of the antenna elements in the nth stage toward the one of the antenna elements in the nth stage; and Zf_#n represents the impedance exerted from the connecting point of the one of the antenna elements in the nth stage toward the output side.
